(19) United States
(12) Patent Application Publication
(10) Pub. No.: US 2026/0361709 A1
(43) Pub. Date: Nov. 12, 2026

(54) SIMPLIFIED AND SECURE ZERO-TOUCH ONBOARDING ONTO NETWORK INFRASTRUCTURE TO ESTABLISH SECURE LINKS ON FIRST CONNECT

(71) Applicant: Cisco Technology, Inc., San Jose, CA (US)

(72) Inventors: Shree N. MURTHY, San Jose, CA (US); Arun G. KHANNA, Sunnyvale, CA (US); Sarath Gorthi SUBRAHMANYA, Bangalore (IN); Manas PATI, San Jose, CA (US)

(21) Appl. No.: 19/430,282

(22) Filed: Dec. 23, 2025

Related U.S. Application Data
(60) Provisional application No. 63/803,519, filed on May 9, 2025.

(51) Int. Cl. H04L 9/40

(52) U.S. Cl. CPC H04L 63/0823; H04L 63/0428; H04L 63/0876

(57) ABSTRACT

The present disclosure provides techniques for automated and secure zero-touch onboarding of access points (APs) to a network infrastructure. An AP connects to a network access switch via a physical link, the AP being pre-installed with a SUDI, transmits a first discovery protocol message to the network access switch, receives a second protocol message from the network access switch, in response to determining that both the AP and the network access switch support MACsec based on the exchanged protocol messages, initiates an authentication session with an authentication server via the network access switch, the authentication session using the SUDI certificate of the AP to establish an authentication, and establishes a MACsec-encrypted link for secure communication between the AP and the network access switch.

### CROSS-REFERENCE TO RELATED APPLICATIONS

This application claims benefit of co-pending United States provisional patent application Serial No. 63/803,519 filed May 9, 2025. The aforementioned related patent application is herein incorporated by reference in its entirety.

### TECHNICAL FIELD

Embodiments presented in this disclosure generally relate to network onboarding. More specifically, embodiments disclosed herein relate to simplified and secure zero-touch onboarding of access points (APs) to a network infrastructure.

### BACKGROUND

Conventional enterprise wireless deployments have challenges in securely onboarding access points (APs) into the network infrastructure. Existing onboarding workflows typically require multiple manual configuration steps, device reboots, and coordination between administrators and authentication services. Such procedures are time-consuming and prone to human error, which increases deployment complexity and introduces potential security vulnerabilities during the initial connection phase. Therefore, the ability to simplify and automate these operations has become a useful goal for modern enterprise security solutions.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example network environment for simplified and secure zero-touch onboarding of access points (APs), according to some embodiments of the present disclosure.

FIG. 2 depicts an example onboarding workflow for automated zero-touch onboarding of APs, according to some embodiments of the present disclosure.

FIG. 3 depicts an example onboarding workflow for automated zero-touch onboarding of APs, according to some embodiments of the present disclosure.

FIG. 4 depicts an example method for automated AP onboarding, according to some embodiments of the present disclosure.

FIG. 5 depicts an example method for automated AP onboarding, according to some embodiments of the present disclosure.

FIG. 6 is a block diagram depicting an example method for automated and secure zero-touch onboarding of APs to a network infrastructure, according to some embodiments of the present disclosure.

FIG. 7 depicts an example network device configured to perform various aspects of the present disclosure, according to some embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method, including connecting, by an access point (AP), to a network access switch via a physical link, the AP being pre-installed with a secure unique device identifier (SUDI), transmitting, by the AP, a first discovery protocol message to the network access switch, the first discovery protocol message comprising information identifying security capacities of the AP, receiving, by the AP, a second protocol message from the network access switch, the second protocol message comprising information identifying security capacities of the network access switch, in response to determining that both the AP and the network access switch support media access control security (MACsec) based on the first and second protocol messages, initiating, by the AP, an authentication session with an authentication server via the network access switch, the authentication session using the SUDI certificate of the AP to establish an authentication, and establishing, by the AP, in response to authentication success, a MACsec-encrypted link for secure communication between the AP and the network access switch.

Other embodiments in this disclosure provide a computer program product comprising one or more computer-readable storage media collectively containing computer-readable program code that, when executed by operation of one or more computer processors, performs operations in accordance with one or more of the above methods, and a system of a network device comprising one or more computer processors, and one or more memories collectively containing one or more programs, which, when executed by the one or more computer processors, perform operations in accordance with one or more of the above methods.

### EXAMPLE EMBODIMENTS

Security is an important requirement for enterprise networks across all industries, including manufacturing, retail, government, healthcare, and other sectors. The process of securely onboarding an access point (AP) to a network infrastructure, however, is typically complex and involves multiple configuration and validation steps. In conventional systems, onboarding requires administrator intervention, device reboots, and manual coordination with authentication services. These multi-step workflows can take several minutes to complete, introducing operational inefficiencies and increasing the likelihood of configuration errors. Furthermore, current deployments often lack first-hop security between the AP and the access switch (the point of attachment into the network infrastructure). The gap can expose the link to man-in-the-middle (MITM) attacks or other interception attempts during the onboarding phase.

Embodiments of the present disclosure introduce methods, systems, and apparatuses that simplify and automate the onboarding of APs into a network infrastructure and ensure that the connection is secure from the first link establishment. The disclosed techniques enable the AP and access switch to automatically discover each other’s security capabilities, authenticate using built-in device credentials, and enable encryption by default. The secure onboarding workflow may be completed within seconds following a one-time, lightweight pre-provisioning operation by a network administrator.

In one embodiment, the disclosed system implements a mechanism for peer capability identification, allowing the AP and access switch to determine whether both devices support Media Access Control Security (MACsec). This may be achieved by extending existing discovery protocols (e.g., Link Layer Discovery Protocol (LLDP) or a vendor-specific Discovery Protocol (DP)) to include additional fields identifying device security capabilities. Through the exchange, peer devices automatically detect mutual MACsec capability and can proceed to establish a secure link upon successful authentication.

In one embodiment, the disclosed system further simplifies the authentication process (e.g., 802.1x-based authentication) for AP onboarding. Upon detecting a peer access switch, the AP initiates an authentication exchange using its manufacturer-installed Secure Unique Device Identifier (SUDI) certificate. The access switch may enforce port-based authentication, optionally with MAC Authentication Bypass (MAB) fallback, and forward authentication messages to an authentication server (e.g., Identity Service Engine (ISE)). The ISE validates the SUDI certificate against a trusted manufacturer root certificate authority (CA) and may further verify the AP’s identity based on a pre-registered whitelist of media access control (MAC) addresses or serial numbers. During the initial stage, the AP operates under a trust-on-first-use (TOFU) model, temporarily trusting the infrastructure and awaiting credential validation. Upon successful SUDI authentication, the AP and access switch can initiate a MACsec Key Agreement (MKA) protocol to establish a link-level encrypted channel to maintain confidentiality and integrity of all layer-2 traffic.

Following SUDI-based authentication, the present disclosure provides two approaches for establishing enterprise trust through provisioning of Locally Significant Certificates (LSCs). In one embodiment, the AP obtains an LSC through a Tunneled Extensible Authentication Protocol (TEAP) exchange with the authentication server. After the SUDI credential is validated, the authentication server provisions an LSC to the AP within the TEAP tunnel. The AP stores the LSC and reinitiates authentication using the LSC credential. Upon successful reauthentication, the AP transitions from limited network access to full operational access and joins the wireless controller, and the AP-switch link remains protected through MACsec encryption.

In another embodiment, the AP authenticates with the network using its SUDI certificate and establishes an encrypted link with the access switch. The AP then obtains an IP address and joins a wireless local area network (LAN) controller (WLC) under restricted policy. The WLC provisions the AP with an LSC or a root CA certificate. The AP subsequently reauthenticates with the authentication server using the LSC credential to gain full network access, or, in some embodiments, the AP gains full access without reauthentication.

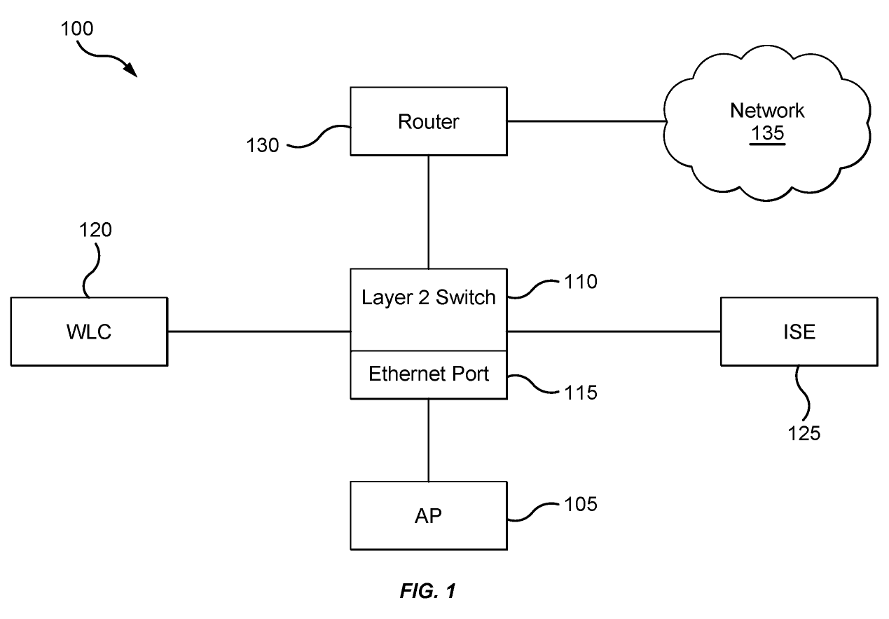

FIG. 1 depicts an example network environment 100 where the disclosed techniques for simplified and secure zero-touch onboarding of APs may be implemented.

The environment 100 includes an access point (AP) 105 communicatively coupled to a layer-2 switch 110 through a physical connection, such as an Ethernet port 115 of the switch. The layer-2 switch 110 is further connected to a wireless local area network (LAN) controller (WLC) 120 and an authentication server, such as an Identity Service Engine (ISE) 125. The ISE 125 performs device authentication and certificate management. The switch 110 may also connect to a router 130, which provides connectivity to an external network 135 (e.g., an enterprise backbone or the Internet).

In conventional onboarding frameworks, multiple manual configuration steps are needed to establish connectivity between the AP 105 and the network infrastructure. These steps include administrator intervention to stage credentials, enable security features, or reboot the AP after configuration. These manual operations make the onboarding process time-consuming and vulnerable to security lapses during the unencrypted first-hop connection.

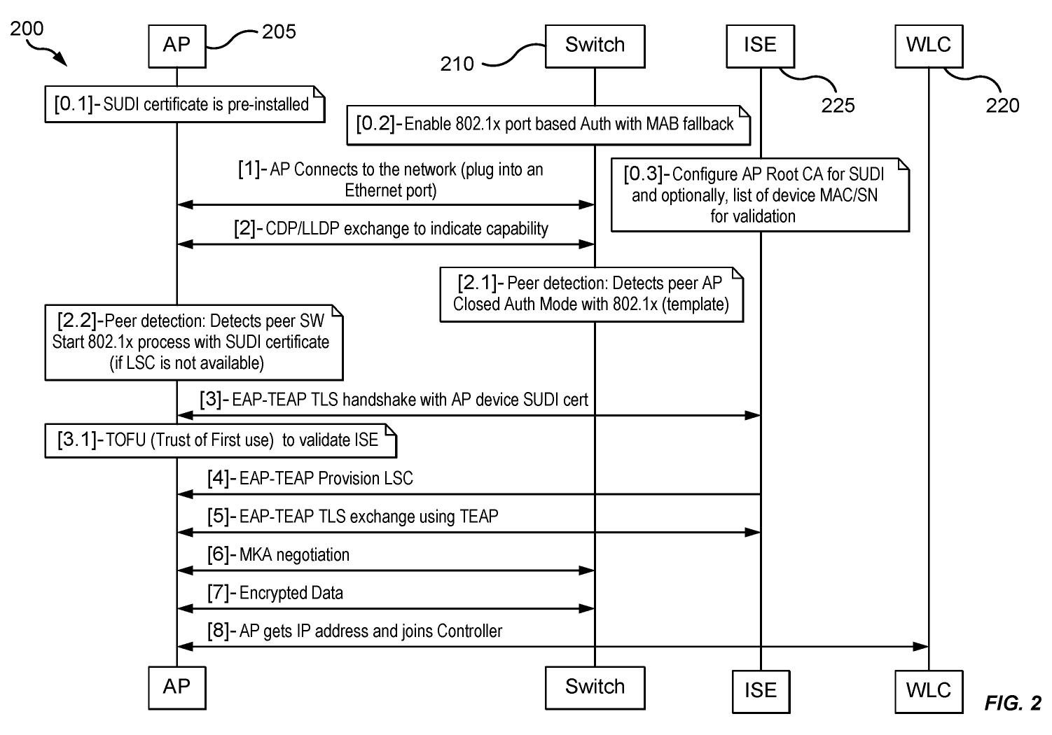

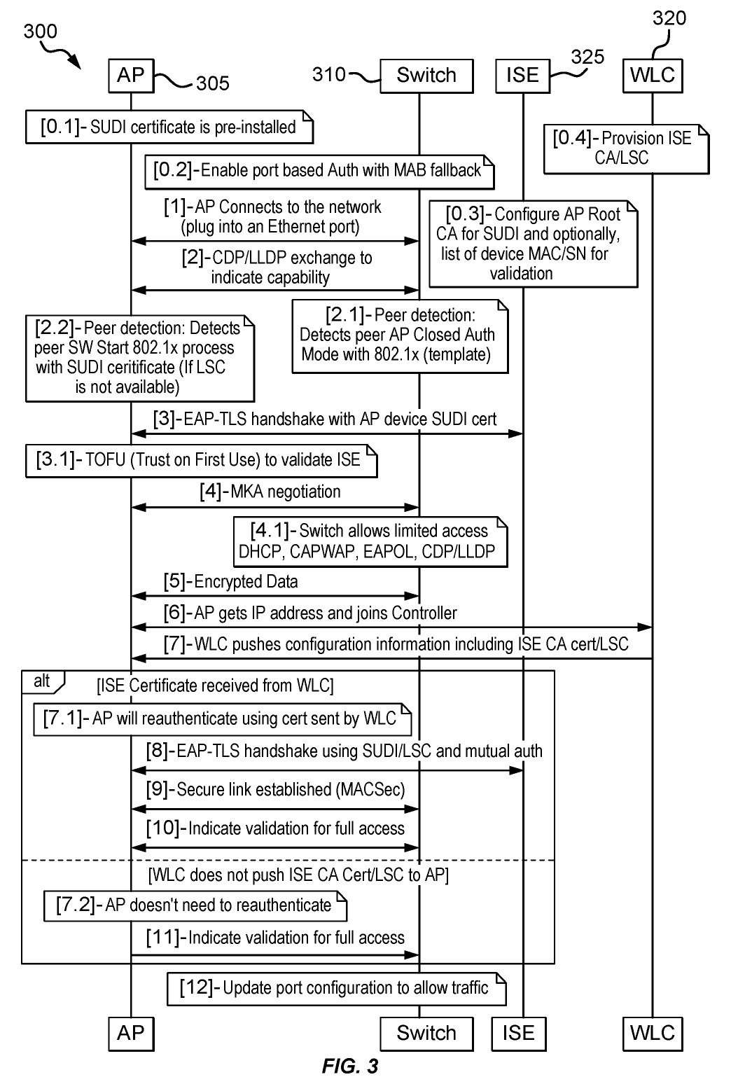

The present disclosure automates the onboarding sequence within the same topology. When the AP 105 connects to the switch 110, the two devices automatically perform peer capability discovery using extended link-layer discovery messages, initiate authentication with the ISE 125 using the AP’s manufacturer-installed secure unique device identifier (SUDI) certificate, and establish a media access control security (MACsec)-encrypted link on first connect. The AP 105 may further obtain a locally significant certificate (LSC) from the ISE 125 or WLC 120 to transition from manufacturer trust to enterprise trust. More details about the automated onboarding process are discussed below with references to FIGS. 2 and 3.

FIG. 2 depicts an example onboarding workflow 200 for automated zero-touch onboarding of APs using a Tunneled Extensible Authentication Protocol (TEAP) authentication exchange. The AP 205 may correspond to AP 105 in FIG. 1, and the switch 210 may correspond to layer-2 switch 110 in FIG. 1. The Identity Service Engine (ISE) 225 may correspond to the ISE 125 in FIG. 1, and the wireless local area network (LAN) controller (WLC) 220 may correspond to the WLC 120 in FIG. 1.

Multiple operations are performed within the infrastructure prior to the onboarding process. As depicted, at step 0.1, AP 205 is preinstalled with a secure unique device identifier (SUDI) certificate at manufacture time. The SUDI certificate serves as the AP’s initial identity credential during onboarding. At step 0.2, the switch 210 is configured to enforce port-based access control authentication (e.g., 802.1x-based authentication), with MAC Authentication Bypass (MAB) fallback enabled to allow limited network communication for discovery and authentication messages prior to successful authentication. At step 0.3, the ISE 225 is configured with a manufacturer root certificate authority (CA) for validating AP SUDI certificates and, in some embodiments, with a list of device identifiers (e.g., MAC addresses or serial numbers (SNs)) for additional validation of authorized devices. These preparatory steps are performed prior to the onboarding process, either concurrently or sequentially.

The automated, zero-touch onboarding process begins at step 1, where the AP 205 is connected to the network, such as by physically plugging into an Ethernet port of the switch 210. As used herein, the operation of connecting the AP 205 to the network access switch 210 includes transmitting data via the physical link once the connection is established.

At step 2, the AP 205 and the switch 210 perform peer capability identification by exchanging discovery protocol messages, such as Link Layer Discovery Protocol (LLDP) or a vendor-specific Discovery Protocol (DP). In the depicted workflow 200, the capability identification is achieved by extending existing LLDP messages to include new information elements for security negotiation. Using these techniques, two peer devices (AP 205 and switch 210) can automatically determine their ability to secure the link (e.g., whether both support Media Access Control Security (MACsec)) and can enable data encryption on the link upon authentication. In some embodiments, the enhancement is implemented by introducing an additional capability bit in the Capability Type-Length-Value (TLV) field to indicate that the device is MACsec-capable (e.g., CDP_MACSEC_CAPABLE_DEVICE). In addition, a new Security TLV is defined to advertise auto-secure enablement (e.g., CDP_TYPE_SECURITY_TLV), with an AUTO_SECURE attribute (e.g., CDP_AUTO_SECURE) that signals the device’s readiness for automatic secure link establishment.

At step 2.1, the switch 210, upon receiving the discovery message from the AP 205, detects that the connected device is MACsec-capable and transitions the corresponding port into a closed authentication model according to an 802.1x authentication template.

At step 2.2, the AP 205 detects, based on the received LLDP or vendor-specific DP response, that the peer switch 210 has initiated the authentication process and is capable of secure onboarding. In response, the AP 205 prepares to authenticate using its SUDI certificate (if a locally significant certificate (LSC) is not yet provisioned).

At step 3, the AP 205 initiates a Tunnel Extensible Authentication Protocol (EAP-TEAP) Transport Layer Security (TLS) handshake with the ISE 225 via the switch 210. The AP 205 presents its manufacturer-installed SUDI certificate for validation. As shown at step 3.1, the AP 205 applies a trust-on-first-use (TOFU) model to validate the authenticity of the ISE 225. Upon successful validation of the SUDI certificate, the AP 205 obtains limited access to the network. The switch 210 permits only restricted control traffic sufficient for completion of the onboarding process, such as extensible authentication protocol over local area network (EAPOL), vendor-specific DP or LLDP, control and provisioning of wireless access points (CAPWAP), or dynamic host configuration protocol (DHCP) messaging.

At step 4, following successful SUDI validation, the ISE 225 provisions an LSC to the AP 205 through the TEAP tunnel. At step 5, the AP 205 reinitiates an EAP-TEAP TLS handshake using the newly provisioned LSC to perform enterprise-level authentication. At step 6, upon successful LSC-based authentication, the AP 205 and switch 210 perform a MACsec Key Agreement (MKA) negotiation to establish link-level encryption on the first-hop connection. At step 7, following the completion of MKA negotiation, the AP 205 and switch 210 exchange encrypted layer-2 frames. The operation ensures confidentiality and integrity of all traffic over the link. Finally, at step 8, the AP 205 obtains an IP address and joins the WLC 220, at which point the port authorization is elevated and the AP transitions from the limited-access state to full network access. At this stage, the zero-touch secure onboarding process is completed.

Through the workflow 200, the AP 205 automatically performs peer discovery, authentication, certificate provisioning, and first-hop encryption without manual intervention or reboot.

FIG. 3 depicts an example onboarding workflow 300 for automated zero-touch onboarding of APs using a WLC-based certificate provisioning process. The AP 305 may correspond to AP 105 in FIG. 1, and the switch 310 may correspond to layer-2 switch 110 in FIG. 1. The ISE 325 may correspond to the ISE 125 in FIG. 1, and the WLC 320 may correspond to the WLC 120 in FIG. 1.

As depicted, at step 0.1, the AP 305 is preinstalled with a SUDI certificate at manufacture time. The SUDI certificate serves as the AP’s initial credential. At step 0.2, the switch 310 is configured to enforce port-based access control authentication (e.g., 802.1x-based authentication) with MAB fallback. At step 0.3, the ISE 325 is configured with the manufacturer’s root CA for validating AP SUDI certificates. In some embodiments, the ISE 325 is further provided with a list of device identifiers (e.g., MAC addresses or serial numbers) for additional verification. At step 0.4, the WLC 320 is provisioned with the ISE CA certificate and enterprise LSC templates to enable downstream distribution of credentials during onboarding. The preparatory steps are performed before the onboarding process begins, either concurrently or sequentially.

At step 1, the AP 305 is connected to the network, such as by plugging into an Ethernet port (e.g., 115 in FIG. 1) of the switch 310. At step 2, the AP 305 and the switch 310 performs peer capability identification through the exchange of LLDP or vendor-specific DP messages to indicate security capability. In some embodiments, the peer capability is indicated by introducing an additional capability bit in the Capability Type-Length-Value (TLV) field to indicate that the device is MACsec-capable (e.g., CDP_MACSEC_CAPABLE_DEVICE), and/or an AUTO_SECURE attribute (e.g., CDP_AUTO_SECURE) in a new Security TLV to signal the device’s readiness for automatic secure link establishment.

At step 2.1, the switch 310 detects the AP as a peer device, transitions the port into a closed authentication mode (e.g., in accordance with an 802.1x template), and begins the authentication process. At step 2.2, the AP 305 detects that the switch 310 has initiated 802.1x authentication and prepares to authenticate using its SUDI certificate (when an LSC is not yet available).

At step 3, the AP 305 and the ISE 325 perform an EAP-TLS handshake using the SUDI certificate to establish a TOFU-based authentication. As shown in step 3.1, the AP 305 applies a TOFU model to validate the identity of the ISE 325 during the exchange.

At step 4, the AP 305 and switch 310 perform MKA negotiation to enable link-level encryption. As shown in step 4.1, the switch 310 places the port in a limited-access state that only permits restricted traffic, such as EAPOL, DHCP, CAPWAP, LLDP/vendor-specific DP messages.

At step 5, the AP 305 and switch 310 exchange encrypted layer-2 frames to protect all link traffic. At step 6, the AP 305 obtains an IP address and joins the WLC 320. The AP 305 still operates under restricted access policies.

At step 7, the WLC 320 pushes configuration information to the AP, including the ISE CA certificate or an LSC. Two situations may occur. The first situation applies when reauthentication is required to establish enterprise trust and obtain full network access. In this case, the ISE certificate and/or LSC are received from the WLC 320. At step 7.1, the AP 305 reauthenticates with the ISE 325 using the credentials sent by the WLC. Step 8, the AP 305 and the ISE 325 perform an EAP-TLS handshake using the SUDI or newly provisioned LSC to achieve mutual authentication. At step 9, a MACsec-secured link is fully established between the AP 305 and switch 310. At step 10, the AP 305 signals to the switch 310 that validation is completed and requests full network access.

The second situation applies when reauthentication is not required, such as when the WLC 320 does not push an ISE CA certificate or LSC to the AP 305, or when enterprise trust is deferred to a later cycle. In this case, at step 7.2, the AP 305 does not perform reauthentication and continues to operate using its existing SUDI credential. At step 11, the AP 305 directly signals to the switch 310 to request full access authorization.

Regardless of which situation applies, at step 12, the switch 310 updates its port configuration to permit unrestricted traffic flow. At this stage, the AP 305 obtains full network access and completes the zero-touch secure onboarding process.

Through the workflow 300, the AP 305 achieves automated, zero-touch onboarding with reauthentication for enterprise trust establishment.

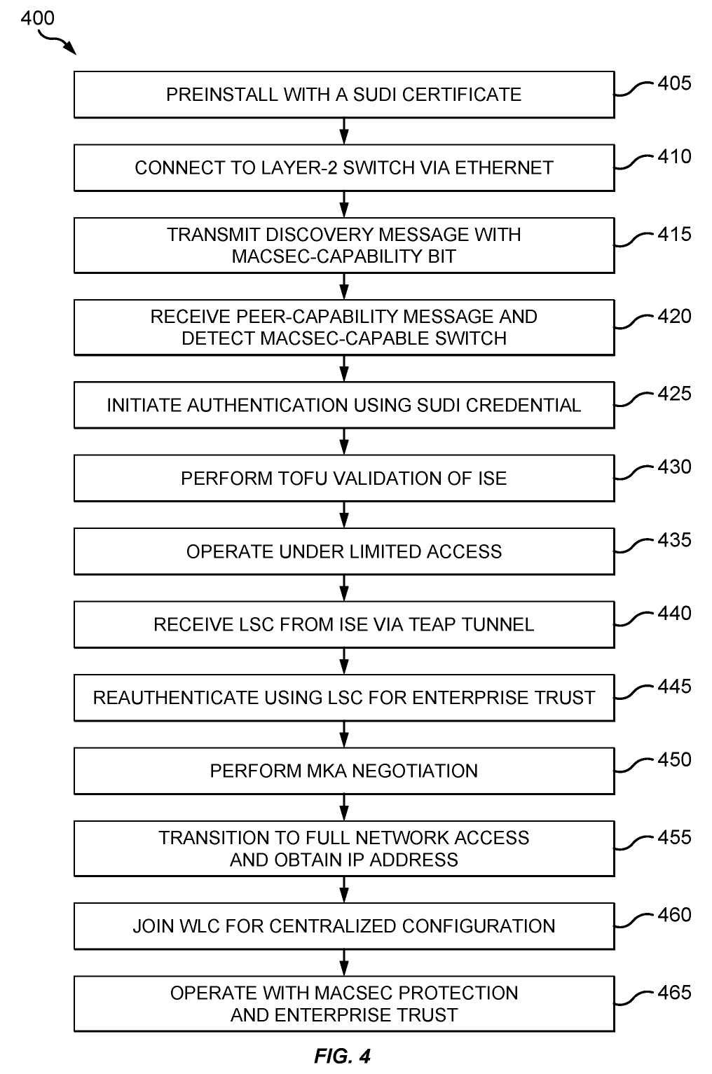

FIG. 4 depicts an example method 400 for automated AP onboarding, according to some embodiments of the present disclosure. The method may be performed by an AP, such as the AP 105 in FIG. 1 or the AP 205 in FIG. 2, or other network devices configured for secure onboarding and link-level authentication.

At block 405, an AP is preinstalled with a SUDI certificate at manufacture time. The SUDI certificate serves as the device’s initial cryptographic identity and is stored in secure hardware.

At block 410, the AP connects to a layer-2 switch (e.g., 110 in FIG. 1 or 210 in FIG. 2) via an Ethernet port. The AP initiates a connection to the network infrastructure and triggers the link-layer discovery process used for peer capability detection.

At block 415, the AP transmits discovery messages (e.g., LLDP or vendor-specific DP messages) to the switch. The discovery message may include extended information elements that advertise the AP’s security capabilities, such as a MACsec-capable bit in the Capability TLV field or an AUTO_SECURE attribute in the Security TLV. The extended information elements indicate that the AP supports automated secure onboarding and link-level encryption.

At block 420, the AP receives corresponding peer-capability messages (e.g., LLDP or vendor-specific DP messages) from the switch and determines that the peer device is also MACsec-capable. Based on the peer-capability identification, the AP detects that the switch port is operating in a closed authentication mode and prepares to begin secure onboarding.

At block 425, the AP initiates an EAP-TEAP TLS authentication with an authentication server (e.g., ISE 225 in FIG. 2) through the switch. The AP uses its SUDI certificate as the credential for device-level authentication.

At block 430, the AP performs a TOFU validation to verify the authenticity of the ISE during the initial handshake. The verification is to ensure that the AP is communicating with a legitimate network authority.

At block 435, after successful SUDI validation, the AP enters a limited access state, where the switch restricts traffic to necessary control and management messages (e.g., EAPOL, LLDP, CAPWAP, or DHCP messages).

At block 440, the AP receives an LSC provisioned by the ISE via the secure TEAP tunnel. The AP may store the LSC to a local memory for subsequent enterprise authentication.

At block 445, the AP reauthenticates using the provisioned LSC. The AP performs a second EAP-TEAP LST exchange with ISE to establish mutual enterprise trust. The operation switches the AP’s trust level from manufacturer-based (SUDI) to enterprise-based (LSC).

At block 450, the AP performs MKA negotiation with the switch to enable link-level encryption. The link-level encryption ensures that all traffic on the first-hop connection is protected against interception or tampering.

Following MACsec enablement and LSC-based authentication, at block 455, the AP obtains full network access and receives an IP address via DHCP. At this stage, the AP gains full layer-3 connectivity within the enterprise network.

At block 460, the AP joins the WLC (e.g., 220 in FIG. 2) using CAPWAP or a relevant protocol for centralized management and configuration.

At block 465, the AP operates in a steady state, including maintaining MACsec-protected link, performing periodic reauthentication using its LSC, and renewing its certificate as required by enterprise policy.

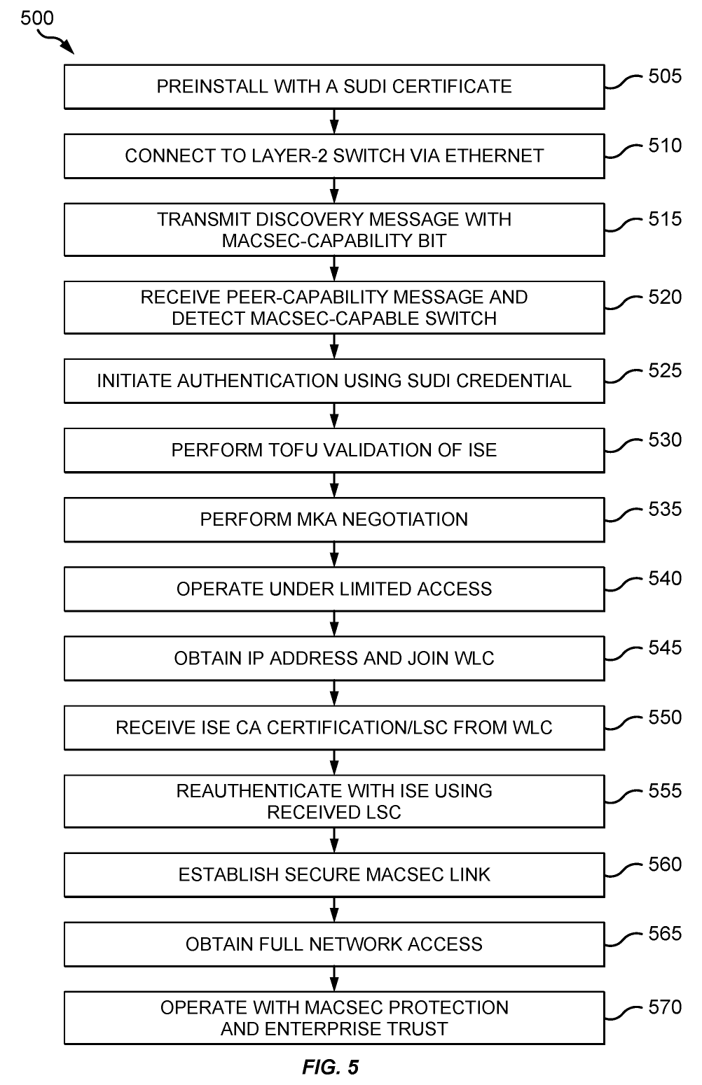

FIG. 5 depicts an example method 500 for automated AP onboarding, according to some embodiments of the present disclosure. The method may be performed by an AP, such as the AP 105 in FIG. 1 or the AP 305 in FIG. 3, or other network devices configured for secure onboarding and link-level authentication.

At block 505, an AP is preinstalled with a SUDI certificate, which serves as the AP’s base credential for identity verification during the onboarding process.

At block 510, the AP connects to a layer-2 switch (e.g., 310 in FIG. 3) via an Ethernet port.

At block 515, the AP transmits discovery messages (e.g., LLDP or vendor-specific DP) to the switch. The discovery message includes an extended Capability TLV comprising a MACsec-capable bit and/or a Security TLV comprising an AUTO_SECURE attribute. These extensions advertise the AP’s ability to support MACsec encryption and auto-secure onboarding.

At block 520, the AP receives peer-capability discovery messages from the switch. Based on the received messages, the AP determines that the switch is also MACsec-capable and identifies the switch as a trusted infrastructure device operating in a closed authentication mode.

At block 525, the AP performs an EAP-TEAP TLS authentication exchange with an authentication server (e.g., ISE 325 in FIG. 3) via the switch. The AP uses its SUDI certificate for device authentication.

At block 530, during the authentication handshake, the AP validates the ISE identity using a TOFU mechanism to ensure the AP is communicating with a legitimate network authority.

At block 535, the AP performs MKA negotiation with the switch to enable link-level encryption and ensure data confidentiality over the first-hop link.

At block 540, the AP operates under limited network access, during which the switch allows only restricted management and control traffic (e.g., EAPOL, LLDP, CAPWAP, or DHCP messages) until the enterprise authentication process is complete.

At block 545, the AP obtains IP address from the network and joins the WLC (e.g., 320 in FIG. 3).

At block 550, the AP receives the ISE CA certificate and/or an LSC from the WLC. The provisioning step allows the AP to establish enterprise-level trust credentials for subsequent reauthentication.

At block 555, the AP reauthenticates with the authentication server (e.g., ISE 325 in FIG. 3) using the newly received LSC via an EAP-TEAP TLS exchange. The AP and switch perform mutual authentication to validate both entities.

At block 560, after successful reauthentication, the AP establishes a secure MACsec link with the switch.

At block 565, the AP transitions to full access that enables unrestricted traffic flow and downloads additional configuration or policy information from the network.

At block 570, the AP operates under a steady state. More specifically, the AP maintains MACsec protection, performs periodic LSC-based reauthentication, and preserves enterprise trust for ongoing secure management.

In some embodiments, WLC may not push an ISE CA certificate or LSC to the AP for establishing enterprise trust. In such configurations, the SUDI-based authentication may be accepted as sufficient for device validation and policy enforcement. Under these circumstances, the AP may directly obtain full access authorization from the switch following successful SUDI authentication and link-level encryption. This approach enables faster onboarding and may be preferred in deployments where SUDI credentials are trusted as enterprise-grade identities.

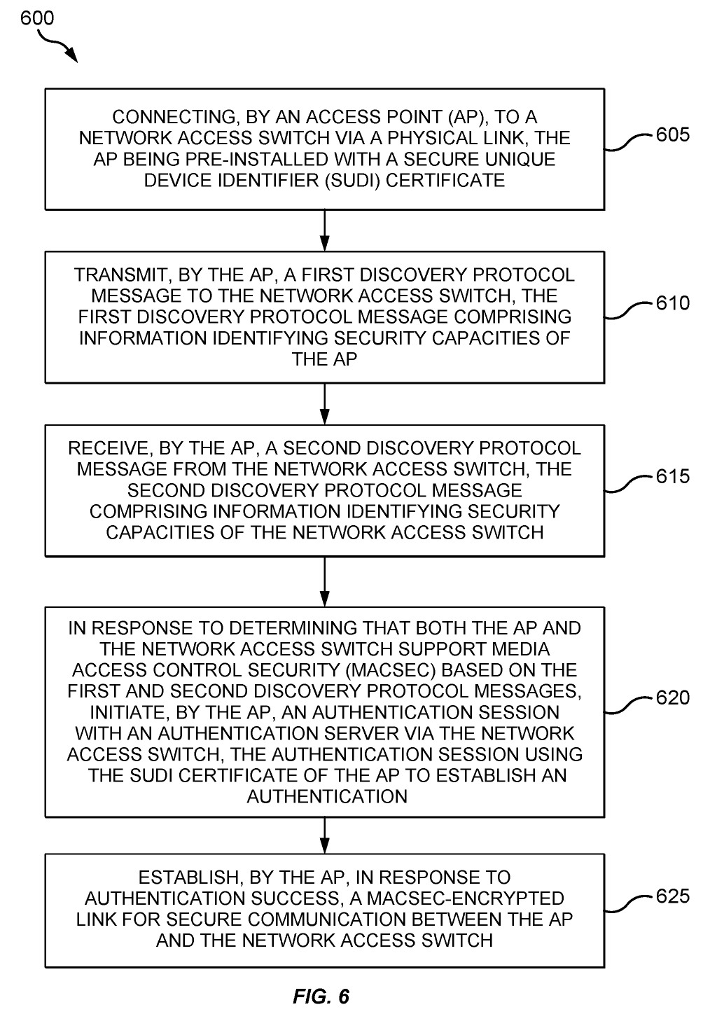

FIG. 6 is a block diagram depicting an example method 600 for automated and secure zero-touch onboarding of APs to a network infrastructure, according to some embodiments of the present disclosure.

At block 605, an access point (AP) connects to a network access switch (e.g., 210 in FIG. 2 or 310 in FIG. 3) via a physical link, the AP being pre-installed with a secure unique device identifier (SUDI) certificate.

At block 610, the AP transmits a first discovery protocol message (e.g., LLDP or vendor-specific DP messages) to the network access switch, the first discovery protocol message comprising information identifying security capacities of the AP.

At block 615, the AP receives a second discovery protocol message from the network access switch, the second discovery protocol message comprising information identifying security capacities of the network access switch.

At block 620, in response to determining that both the AP and the network access switch support media access control security (MACsec) based on the first and second discovery protocol messages, the AP initiates an authentication session with an authentication server (e.g., 225 in FIG. 2 or 325 in FIG. 3) via the network access switch, the authentication session using the SUDI certificate of the AP to establish an authentication.

At block 625, in response to authentication success, the AP establishes a MACsec-encrypted link for secure communication between the AP and the network access switch.

In some embodiments, the AP receives a locally significant certificate (LSC) provisioned from the authentication server via a tunneled extensible authentication protocol (TEAP) exchange, reinitiates a second authentication session with the authentication server using the LSC as a device credential, and obtains a full network access to an enterprise network from the network access switch.

In some embodiments, the AP joins a wireless local area network (LAN) controller (WLC) after establishing the MACsec-encrypted link, receives, from the WLC, a locally significant certificate (LSC) or one or more root certificate authority (CA) certificates, reinitiates a second authentication session with the authentication server using the LSC as a device credential, and obtains a full network access to an enterprise network from the network access switch.

In some embodiments, the AP operates under a trust-on-first-use (TOFU) model, and the AP temporarily trusts the network access switch until successful validation of the SUDI certificate by the authentication server.

In some embodiments, the MACsec-encrypted link permits only restricted network traffic comprising at least one of: one or more dynamic host configuration protocol (DHCP) messages, one or more control and provisioning of wireless access points (CAPWAP) message, one or more extensible authentication protocol over local area network (EAPOL) messages, or discovery protocol (DP) or link layer discovery protocol (LLDP) messages.

In some embodiments, the network access switch is configured to enforce port-based authentication on the physical link and to apply media access control (MAC) authentication bypass (MAB) fallback to allow restricted connectivity.

In some embodiments, the authentication server is configured with one or more of: a root certificate authority (CA) certificate corresponding to a manufacturer of the AP for validating the SUDI certificate of the AP, or a list of device identifiers comprising at least one of a media access control (MAC) address or a serial number of the AP.

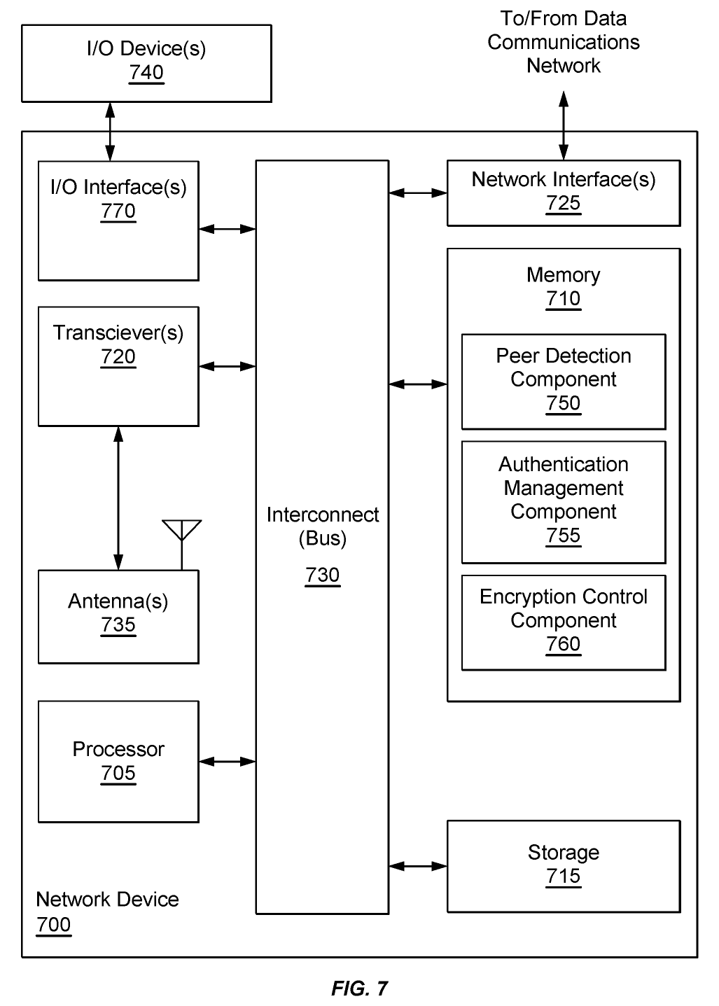

FIG. 7 depicts an example network device 700 configured to perform various aspects of the present disclosure, according to some embodiments of the present disclosure. The network device 700 may correspond to an AP (e.g., the AP 105 in FIG. 1, AP 205 in FIG. 2, or the AP 305 in FIG. 3) or other network devices configured for secure onboarding and link-level authentication.

As illustrated, the network device 700 includes a processor 705, memory 710, storage 715, one or more transceivers 720, one or more I/O interfaces 790, and one or more network interfaces 725. In some embodiments, I/O devices 740 are connected via the I/O interface(s) 780. Further, via the network interface 725, the network device 700 can be communicatively coupled with one or more other devices and components (e.g., via a network, which may include the Internet, local network(s), and the like). Each of the components is communicatively coupled by one or more buses 730. In some embodiments, one or more antennas 735 may be coupled to the transceivers 720 for transmitting and receiving wireless signals.

The processor 705 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 705 processes information received through the transceiver 720, I/O interfaces 790, and the network interfaces 725. The processor 705 retrieves and executes programming instructions stored in memory 710, as well as stores and retrieves application data residing in storage 715.

The storage 715 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 715 may store a variety of data for the efficient functioning of the system.

The memory 710 may include random access memory (RAM) and read-only memory (ROM). The memory 710 may store processor-executable software code containing instructions that, when executed by the processor 705, enable the network device 700 to perform various functions described herein for wireless communication.

As depicted, the memory 710 includes a peer detection component 750, an authentication management component 755, and an encryption control component 760.

In one embodiment, the peer detection component 750 is configured to manage the device’s pre-installed credentials (SUDI) and perform peer-capability discovery with a connected network switch. More specifically, the peer detection component 750 may access and store the manufacturer-installed SUDI certificate, compose and transmit LLDP or vendor-specific DP messages including extended Capability TLV and Security TLV fields, and detect the peer’s capability to support MACsec and automatic secure onboarding. The peer detection component 750 may further determine when the peer device operates in a closed authentication mode and trigger the start of the onboarding process.

In one embodiment, the authentication management component 755 is configured to manage the secure authentication workflow using either the SUDI certificate or an LSC. The authentication management component 755 may initiate and control EAP exchanges, perform TOFU validation of the authentication server, coordinate reauthentication using an LSC when enterprise trust is required, and manage transitions between limited-access and full-access operational states based on the authentication result.

In one embodiment, the encryption control component 760 is configured to establish and maintain link-level encryption on the first hop between the AP and the network switch. The encryption control component 760 may execute MKA procedures to derive encryption and integrity keys, enable secure data exchange once authentication is complete, and monitor the encryption session for key rotation or rekeying events.

Although depicted as a discrete component for conceptual clarity, in some embodiments, the operations of the depicted components (and others not illustrated) may be combined or distributed across any number of components. Further, although depicted as software residing in memory 710, in some embodiments, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
connecting, by an access point (AP), to a network access switch via a physical link, the AP being pre-installed with a secure unique device identifier (SUDI) certificate;
transmitting, by the AP, a first discovery protocol message to the network access switch, the first discovery protocol message comprising information identifying security capacities of the AP;
receiving, by the AP, a second discovery protocol message from the network access switch, the second discovery protocol message comprising information identifying security capacities of the network access switch;
in response to determining that both the AP and the network access switch support media access control security (MACsec) based on the first and second discovery protocol messages, initiating, by the AP, an authentication session with an authentication server via the network access switch, the authentication session using the SUDI certificate of the AP to establish an authentication; and
establishing, by the AP, in response to authentication success, a MACsec-encrypted link for secure communication between the AP and the network access switch.

2. The method of claim 1, further comprising:
receiving, by the AP, a locally significant certificate (LSC) provisioned from the authentication server via a tunneled extensible authentication protocol (TEAP) exchange;
reinitiating, by the AP, a second authentication session with the authentication server using the LSC as a device credential; and
obtaining, by the AP, a full network access to an enterprise network from the network access switch.

3. The method of claim 1, further comprising:
joining, by the AP, a wireless local area network (LAN) controller (WLC) after establishing the MACsec-encrypted link;
receiving, by the AP, from the WLC, a locally significant certificate (LSC) or one or more root certificate authority (CA) certificates;
reinitiating, by the AP, a second authentication session with the authentication server using the LSC as a device credential; and
obtaining, by the AP, a full network access to an enterprise network from the network access switch.

4. The method of claim 1, wherein the AP operates under a trust-on-first-use (TOFU) model, and the AP temporarily trusts the network access switch until successful validation of the SUDI certificate by the authentication server.

5. The method of claim 1, wherein the MACsec-encrypted link permits only restricted network traffic comprising at least one of:
one or more dynamic host configuration protocol (DHCP) messages,
one or more control and provisioning of wireless access points (CAPWAP) message,
one or more extensible authentication protocol over local area network (EAPOL) messages, or
discovery protocol (DP) or link layer discovery protocol (LLDP) messages.

6. The method of claim 1, wherein the network access switch is configured to enforce port-based authentication on the physical link and to apply media access control (MAC) authentication bypass (MAB) fallback to allow restricted connectivity.

7. The method of claim 1, wherein the authentication server is configured with one or more of:
a root certificate authority (CA) certificate corresponding to a manufacturer of the AP for validating the SUDI certificate of the AP, or
a list of device identifiers comprising at least one of a media access control (MAC) address or a serial number of the AP.

8. A system of an access point (AP), comprising:
one or more computer processors; and
one or more memories collectively containing one or more programs, which, when executed by the one or more computer processors, perform an operation, the operation comprising:
connecting, by the AP, to a network access switch via a physical link, the AP being pre-installed with a secure unique device identifier (SUDI) certificate;
transmitting, by the AP, a first discovery protocol message to the network access switch, the first discovery protocol message comprising information identifying security capacities of the AP;
receiving, by the AP, a second discovery protocol message from the network access switch, the second discovery protocol message comprising information identifying security capacities of the network access switch;
in response to determining that both the AP and the network access switch support media access control security (MACsec) based on the first and second discovery protocol messages, initiating, by the AP, an authentication session with an authentication server via the network access switch, the authentication session using the SUDI certificate of the AP to establish an authentication; and
establishing, by the AP, in response to authentication success, a MACsec-encrypted link for secure communication between the AP and the network access switch.

9. The system of claim 8, wherein the operation further comprises:
receiving, by the AP, a locally significant certificate (LSC) provisioned from the authentication server via a tunneled extensible authentication protocol (TEAP) exchange;
reinitiating, by the AP, a second authentication session with the authentication server using the LSC as a device credential; and
obtaining, by the AP, a full network access to an enterprise network from the network access switch.

10. The system of claim 8, wherein the operation further comprises:
joining, by the AP, a wireless local area network (LAN) controller (WLC) after establishing the MACsec-encrypted link;
receiving, by the AP, from the WLC, a locally significant certificate (LSC) or one or more root certificate authority (CA) certificates;
reinitiating, by the AP, a second authentication session with the authentication server using the LSC as a device credential; and
obtaining, by the AP, a full network access to an enterprise network from the network access switch.

11. The system of claim 8, wherein the AP operates under a trust-on-first-use (TOFU) model, and the AP temporarily trusts the network access switch until successful validation of the SUDI certificate by the authentication server.

12. The system of claim 8, wherein the MACsec-encrypted link permits only restricted network traffic comprising at least one of:
one or more dynamic host configuration protocol (DHCP) messages,
one or more control and provisioning of wireless access points (CAPWAP) message,
one or more extensible authentication protocol over local area network (EAPOL) messages, or
vendor-specific discovery protocol (DP) or link layer discovery protocol (LLDP) messages.

13. The system of claim 8, wherein the network access switch is configured to enforce port-based authentication on the physical link and to apply media access control (MAC) authentication bypass (MAB) fallback to allow restricted connectivity.

14. The system of claim 8, wherein the authentication server is configured with one or more of:
a root certificate authority (CA) certificate corresponding to a manufacturer of the AP for validating the SUDI certificate of the AP, or
a list of device identifiers comprising at least one of a media access control (MAC) address or a serial number of the AP.

15. A computer program product comprising one or more computer-readable storage media collectively containing computer-readable program code that, when executed by operation of one or more computer processors, performs an operation comprising:
connecting, by an access point (AP), to a network access switch via a physical link, the AP being pre-installed with a secure unique device identifier (SUDI) certificate;
transmitting, by the AP, a first discovery protocol message to the network access switch, the first discovery protocol message comprising information identifying security capacities of the AP;
receiving, by the AP, a second discovery protocol message from the network access switch, the second discovery protocol message comprising information identifying security capacities of the network access switch;
in response to determining that both the AP and the network access switch support media access control security (MACsec) based on the first and second discovery protocol messages, initiating, by the AP, an authentication session with an authentication server via the network access switch, the authentication session using the SUDI certificate of the AP to establish an authentication; and
establishing, by the AP, in response to authentication success, a MACsec-encrypted link for secure communication between the AP and the network access switch.

16. The computer program product of claim 15, wherein the operation further comprises:
receiving, by the AP, a locally significant certificate (LSC) provisioned from the authentication server via a tunneled extensible authentication protocol (TEAP) exchange;
reinitiating, by the AP, a second authentication session with the authentication server using the LSC as a device credential; and
obtaining, by the AP, a full network access to an enterprise network from the network access switch.

17. The computer program product of claim 15, wherein the operation further comprises:
joining, by the AP, a wireless local area network (LAN) controller (WLC) after establishing the MACsec-encrypted link;
receiving, by the AP, from the WLC, a locally significant certificate (LSC) or one or more root certificate authority (CA) certificates;
reinitiating, by the AP, a second authentication session with the authentication server using the LSC as a device credential; and
obtaining, by the AP, a full network access to an enterprise network from the network access switch.

18. The computer program product of claim 15, wherein the AP operates under a trust-on-first-use (TOFU) model, and the AP temporarily trusts the network access switch until successful validation of the SUDI certificate by the authentication server.

19. The computer program product of claim 15, wherein the MACsec-encrypted link permits only restricted network traffic comprising at least one of:
one or more dynamic host configuration protocol (DHCP) messages,
one or more control and provisioning of wireless access points (CAPWAP) message,
one or more extensible authentication protocol over local area network (EAPOL) messages, or
discovery protocol (DP) or link layer discovery protocol (LLDP) messages.

20. The computer program product of claim 15, wherein the network access switch is configured to enforce port-based authentication on the physical link and to apply media access control (MAC) authentication bypass (MAB) fallback to allow restricted connectivity.
